(19) United States
(12) Patent Application Publication
(10) Pub. No.: US 2012/0147456 A1
(43) Pub. Date: Jun. 14, 2012

(54) WAVELENGTH SELECTIVE REFLECTION ELEMENT, WAVELENGTH SELECTIVE REFLECTION UNIT, AND REFLECTIVE DISPLAY DEVICE

(75) Inventors: Hiroaki Shigeta, Osaka-shi (JP); Yuhji Yashiro, Osaka-shi (JP)

(73) Assignee: SHARP KABUSHIKI KAISHA, Osaka-shi, Osaka (JP)

(21) Appl. No.: 13/389,560

(22) PCT Filed: May 12, 2010
(86) PCT No.: PCT/JP2010/058062

§ 371 Date: Feb. 8, 2012

(30) Foreign Application Priority Data
Sep. 9, 2009 (JP) 2009-208579

(51) Int. Cl. G02F 1/167

(52) U.S. Cl. 359/296

(57) ABSTRACT

A wavelength selective reflection element according to the present invention includes: an upper transparent plate (12) on which a guide-mode resonant grating (11) is formed; a lower transparent plate (13) disposed facing the upper transparent plate (12); and MEMS switches (14) and (15) being microelectromechanical systems, provided on (i) a side of one edge of the upper transparent plate (12) and a corresponding one edge of the lower transparent plate (13) and (ii) a side of another edge of the substrate and a corresponding another edge of the transparent plate, the side of the another edge being a side of an edge of the upper transparent plate (12) and a corresponding edge of the lower transparent plate (13) which faces the side of the one edge. This allows for causing a change in a gap between the upper transparent plate (12) and the lower transparent plate (13), by driving at least one of the MEMS switches.

### REFERENCE TO RELATED APPLICATIONS

This application is the national stage under 35 USC 371 of International Application No. PCT/JP2010/058062, filed May 12, 2010, which claims priority from Japanese Patent Application No. 2009-208579, filed Sep. 9, 2009, the entire contents of which are incorporated herein by reference.

### FIELD OF THE INVENTION

The present invention relates to (i) a wavelength selective reflection element which selectively reflects light of a specific wavelength band in incident light, (ii) a wavelength selective reflection unit in which a plurality of wavelength selective reflection elements are arranged, and (iii) a reflective display device carrying out display in which one wavelength selective reflection unit serves as one picture element.

### BACKGROUND OF THE INVENTION

In recent years, reflective displays represented by “electronic paper” have been attracting attention, as resource-saving and energy-saving next-generation display devices.

The reflective “electronic paper” which take in external light such as fluorescent light and sunlight and which has these light be reflected inside and taken out to display an image, has a wide viewing angle, and is easily viewed even if direct sunlight is on the display. Moreover, none or only a slight amount of power is consumed while displaying the image, and the power consumption when rewriting the display is also very small in amount.

Currently, the mainstream of the “electronic paper” is monochrome (black and white) display, and various methods have been studied, such as electrophoretic display and electrofluidic display.

The electrophoretic display contains many white particles of charged titanium oxide and many black particles of carbon black inside a microcapsule sized approximately of a cut plane of a piece of hair, and a voltage is applied to move the black and white particles, whereby a black and white display is performed. However, response speed of the electrophoretic display is extremely slow, and thus has a problem that moving images cannot be displayed by use of the electrophoretic display.

The electrofluidic powder is one type of display material, and is of macromolecular polymer fine particles. The particles are made of an organic compound onto which a special process is employed, and although it is powder, it has high fluidity as like liquid. The electrofluidic powder has excellent reflectance, viewing angle, and energy-saving properties, and the response speed is remarkably faster than liquid crystal. Therefore, with the electrofluidic display, it is possible to reproduce a moving image with remarkably high definition display as compared to a conventional liquid crystal display.

More specifically, as illustrated in FIG. 16, white electrofluidic powder 403 and black electrofluidic powder 404 are enclosed between a transparent substrate 401 and a transparent substrate 402. The black electrofluidic powder 404 is charged positive, and the white electrofluidic powder 403 is charged negative. When a positive voltage is applied to the transparent substrate 401, the white electrofluidic powder 403 having the negative charge are drawn towards the transparent substrate 401, which causes a surface of the transparent substrate 401 to appear white, whereas in an opposite case, the surface of the transparent substrate 401 is caused to appear black. This allows for switching over between black and white. Conversion to color can be achieved by providing a color filter 405 on the transparent substrate 401. However, material composition of a color filter which strongly absorbs light causes a decrease in reflectance to for example not more than 30%. This causes a problem of having low brightness.

In order to solve the problem of the decrease in reflectance, studies have been made of wavelength selective elements which can efficiently select light of a specific wavelength and which is applicable to electronic paper. One known example is an optical device which installs a microelectromechanical system called MEMS (Micro Electro Mechanical Systems). The MEMS is a device in which, other than machine element parts, a sensor, an actuator or an electronic circuit is accumulated on a silicon substrate, glass substrate, organic material or the like.

A MEMS interference modulator is a typical optical device on which the MEMS is mounted. For example, Patent Literature 1 discloses a display device which includes an array of MEMS interference modulators.

Described below is the foregoing display device, with reference to FIG. 17.

A pixel array illustrated in FIG. 17 includes two adjacent interference modulators 112a and 112b. The interference modulator 112a includes a movable reflective layer 114a and a fixed partial reflective layer 116a, and the interference modulator 112b includes a movable reflective layer 114b and a fixed partial reflective layer 116b. While no voltage is applied to the interference modulator, the movable reflective layer 114a is in a released position as illustrated as the interference modulator 112a, and a gap 119. remains between the movable reflective layer 114a and the fixed partial reflective layer 116a. On the other hand, when a voltage is applied to the interference modulator, the movable reflective layer 114b moves to an operation position caused by static electricity as illustrated as the interference modulator 112b. As a result, the movable reflective layer 114b is in contact with the fixed partial reflective layer 116b.

During a state as illustrated as the interference modulator 112a, most of incident visible light is reflected, and during a state as illustrated as the interference modulator 112b, hardly any light is reflected. Namely, Patent Literature 1 discloses controlling of reflecting and not reflecting the light by moving the movable reflective layer 114a or 114b up and down.

Patent Literature 2 discloses in detail of the conversion to color of the display device proposed in Patent Literature 1.

Described below is one embodiment of the conversion to color of the display device, with reference to FIG. 18.

As illustrated in FIG. 18, an interference modulator array 210 includes three modulators, 220, 222, and 224. Each of these modulators includes a movable surface 214 and a fixed surface 212. A gap between the movable surface 214 and the fixed surface 212 is set as d1 in the modulator 220, is set as d2 in the modulator 222, and is set as d3 in the modulator 224. As such, by adjusting the gap, an optical path length is varied, which causes a change in the color reflected by the modulators. For example, to a wavelength of light of red, green, and blue, each of the modulators 220, 222, and 224 is configured to reflect light of a specific color that is different from each other.

Meanwhile, Guide-mode Resonant Grating (GMRG) is known as an element which can selectively reflect light of a specific wavelength. The guide-mode resonant grating is a transparent optical waveguide to which minute bumps and recesses have been processed. This waveguide has a property that light other than that having a wavelength region which satisfies a specific condition, called a phase matching condition, is transmitted through the waveguide. Light which satisfies the phase matching condition and which propagate into the waveguide is returned back to a side from which the light is incident, caused by diffraction and interference effect due to the projections and depressions processed on the waveguide. Hence, an effect is demonstrated to selectively reflect the light of a specific wavelength.

For example, Patent Literature 3 discloses an optical filter including a resonant grating of a simple configuration, with use of the MEMS technique.

As shown in FIG. 19, an optical filter has an insulating film 303, supporting insulators 302, and a resonant grating film 301 stacked on a conductive transparent substrate 304 that serves as a lower electrode. The supporting insulators 302 serve as spacers for forming a gap 306 between the resonant grating 305 and the insulating film 303, while also fixing and supporting the resonant grating 305 and the insulating film 303 at end parts of the resonant grating 305 and the insulating film 303.

Patent Literature 3 discloses that the resonant grating 305 can select a resonant wavelength among incident light and can take this out to the incident side by changing a period of the grating, and further that the reflectance of incident light is changeable by applying a voltage between the transparent substrate 304 and the resonant grating 305, to cause a change in the gap 306.

### CITATION LIST

### Patent Literature 1

Japanese Patent Application Publication, Tokukai, No. 2006-119630 A (Publication Date: May 11, 2006)

### Patent Literature 2

Japanese Patent Application Publication, Tokukai, No. 2006-99070 A (Publication Date: Apr. 13, 2006)

### Patent Literature 3

Japanese Patent Application Publication, Tokukai, No. 2005-331581 A (Publication Date: Dec. 2, 2005)

### Patent Literature 4

Japanese Patent Application Publication, Tokukai, No. 2006-99113 A (Publication Date: Apr. 13, 2006)

### Patent Literature 5

Japanese Patent Application Publication, Tokukai, No. 2006-99087 A (Publication Date: Apr. 13, 2006)

### SUMMARY OF INVENTION

However, the display devices of Patent Literatures 1 and 2, and further the optical filter of Patent Literature 3 are all configurations which apply a voltage to the entire interference modulator or the entire resonant grating, to cause a change in the gap for changing the reflectance. Therefore, this causes a problem that a high voltage and power is required. Particularly, with the optical filter of Patent Literature 3, a high voltage and power of an unpractical amount of several ten V is required.

Moreover, the display devices of Patent Literatures 1 and 2, to achieve an interference effect by reflectance between the two layers as described above, use metal material such as aluminum for the movable layer, which metal material is highly conductive and has reflectivity. The reflection of unnecessary light (reflection of approximately 5%) in the movable layer causes a decrease in contrast.

Furthermore, in a case of a method in which light of a specific wavelength is taken out by use of an interference effect caused by reflection between the two layers, a half bandwidth of a reflected color spectrum becomes great. This causes a problem that a color gamut becomes narrow.

Not only this, it is necessary to adjust the gap between the two layers in high accuracy. An error in nm order causes a problem of not being able to obtain an expected color.

On the other hand, the optical filter of Patent Literature 3 cannot use an insulating product such as resin for the resonant grating as described above. Hence, there are many limits in its practicality and processability. Moreover, since a supporting insulator for supporting the resonant grating and the insulating film is disposed on edges of the resonant grating, this causes a problem that no reflectance change can be achieved at the edges of the resonant grating.

The present invention is accomplished in view of the problems, and its object is to provide a wavelength selective reflection element, a wavelength selective reflection unit, and a reflective display device, each with low power consumption and with excellent workability.

In order to attain the object, a wavelength selective reflection element of the present invention includes: a transparent plate on which a guide-mode resonant grating is formed; a substrate disposed facing the transparent plate; and MEMS being microelectromechanical systems, provided on (i) a side of one edge of the substrate and a corresponding one edge of the transparent plate and (ii) a side of another edge of the substrate and a corresponding another edge the transparent plate, the side of the another edge being a side of an edge of the substrate and a corresponding edge of the transparent plate which faces the side of the one edge, at least one of the MEMS being driven to cause a change in a gap provided between the transparent plate and the substrate.

According to the configuration, application of a voltage to just at least one of microelectromechanical systems (hereinafter, abbreviated as MEMS) to operate the MEMS causes a change in a gap provided between a transparent plate and a substrate, whereby changing reflectance of light selected by the guide-mode resonant grating and having a specific wavelength band.

For example, in a state in which the gap between the transparent plate and the substrate is 0, the reflectance of light by the guide-mode resonant grating is of a minimum value such as 0, and in a state in which a gap is provided between the transparent plate and the substrate, the reflectance is of a maximum value.

Moreover, in a case where a driven amount of an MEMS disposed on a side of one edge of the transparent plate and the substrate is made equal to a driven amount of an MEMS disposed on a side of another edge of the transparent plate and the substrate, the change in the gap can be made while the substrate and the transparent plate maintain their parallel disposition.

On the other hand, in a case where just one of the two MEMS were operated, it is possible to change the gap in a state in which the substrate is tilted with respect to the transparent plate. This allows for obtaining a reflectance having a value intermediate of the minimum value and the maximum value.

Furthermore, the state in which the gap is 0 may be at a time when the driving of the MEMS is ON or when the driving of the MEMS is OFF.

As described above, there is no need to directly apply a voltage to the transparent plate and the substrate to change the reflectance. This allows for reducing power consumption. Moreover, since insulating material such as transparent resin may be used as the transparent plate, it is easy to process the transparent plate, which makes handling thereof easy.

As described above, the wavelength selective reflection element of the present invention includes: a transparent plate on which a guide-mode resonant grating is formed; a substrate disposed facing the transparent plate; and MEMS being microelectromechanical systems, provided on (i) a side of one edge of the substrate and a corresponding one edge of the transparent plate and (ii) a side of another edge of the substrate and a corresponding another edge of the transparent plate, the side of the another edge being a side of an edge of the substrate and the transparent plate which faces the side of the one edge, at least one of the MEMS being driven to cause a change in a gap provided between the transparent plate and the substrate.

Moreover, as described above, the reflective display device of the present invention includes the wavelength selective reflection element.

Hence, an effect is brought about that it is possible to achieve a wavelength selective reflection element which is low in power consumption and which is easy to produce, and achieve a reflective display device including the wavelength selective reflection element.

### BRIEF DESCRIPTION OF DRAWINGS

FIG. 1 is a side view schematically illustrating a configuration of a principal mechanism of a wavelength selective reflection element according to Embodiment 1 of the present invention; (a) illustrates a state in which reflective light is generated, and (b) illustrates a state in which no light is generated.

FIG. 2 is a plan view illustrating a configuration in which MEMS electrode wires are provided in the wavelength selective reflection element of FIG. 1; (a) illustrates a wiring example, and (b) illustrates another wiring example.

FIG. 3 is a view schematically illustrating a configuration of a principal mechanism of a display device according to Embodiment 1 of the present invention.

FIG. 4 is a view related to a wavelength selective reflection unit; (a) is a perspective view illustrating a configuration of the wavelength selective reflection unit, and (b) is a cross-sectional view of a configuration of one pixel in the wavelength selective reflection unit.

FIG. 5 is a cross-sectional view schematically illustrating a principle of operation when the wavelength selective reflection element is in an active state.

FIG. 6 is a cross-sectional view schematically illustrating a principle of operation when the wavelength selective reflection element is in an inactive state.

FIG. 7 is a cross-sectional view schematically illustrating a state in which the wavelength selective reflection element carries out halftone display.

FIG. 8

Illustrated in (a) and (b) are plan views each schematically illustrating a configuration of one picture element in which an R pixel, G pixel, and B pixel serve as one set, and (c) is a view schematically illustrating a principle mechanism of a display device.

FIG. 9 is a conceptual view illustrating spectral characteristics and a color gamut of a wavelength selective reflection element of the present invention.

FIG. 10 is a process view illustrating processes of producing a guide-mode resonant grating of a wavelength selective reflection element, in order of the processes.

FIG. 11 is a view schematically illustrating a principal mechanism of a display device according to Embodiment 2 of the present invention.

FIG. 12 is a perspective view illustrating a configuration of a pixel in the display device of FIG. 11.

FIG. 13 is a cross-sectional view taken on A-B of FIG. 12, and is a cross-sectional view for describing a wavelength selecting operation of the pixel illustrated in FIG. 12.

FIG. 14 is a view schematically illustrating a state in which pixels display a same color, in a display device according to the present Embodiment 2.

FIG. 15 is a perspective view illustrating a mode in which a configuration of the R pixel, G pixel, and B pixel is modified, so that a wavelength selective reflection unit having a stacked structure of wavelength selective reflection elements can carry out gradation display of multiple stages.

FIG. 16 is a cross-sectional view schematically illustrating a configuration of an electrofluidic display of a conventional “electronic paper”.

FIG. 17 is a perspective view illustrating a configuration of a MEMS interference modulator disclosed in Patent Literature 1.

FIG. 18 is a cross-sectional view schematically illustrating a configuration of a MEMS interference modulator disclosed in Patent Literature 2.

FIG. 19 is a cross-sectional view schematically illustrating a configuration of an optical filter disclosed in Patent Literature 3.

### DETAILED DESCRIPTION OF THE INVENTION

Described below is a specific explanation of an embodiment of the present invention.

### Embodiment 1

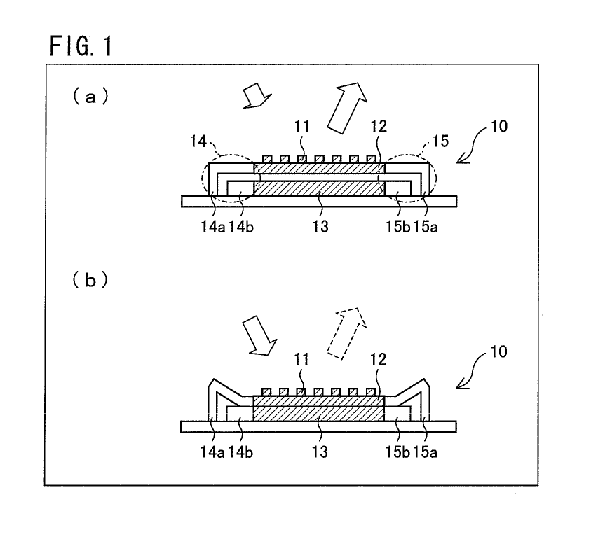

One embodiment of the present invention is described below, with reference to FIGS. 1 through 10.

(Principal Part of Display Device)

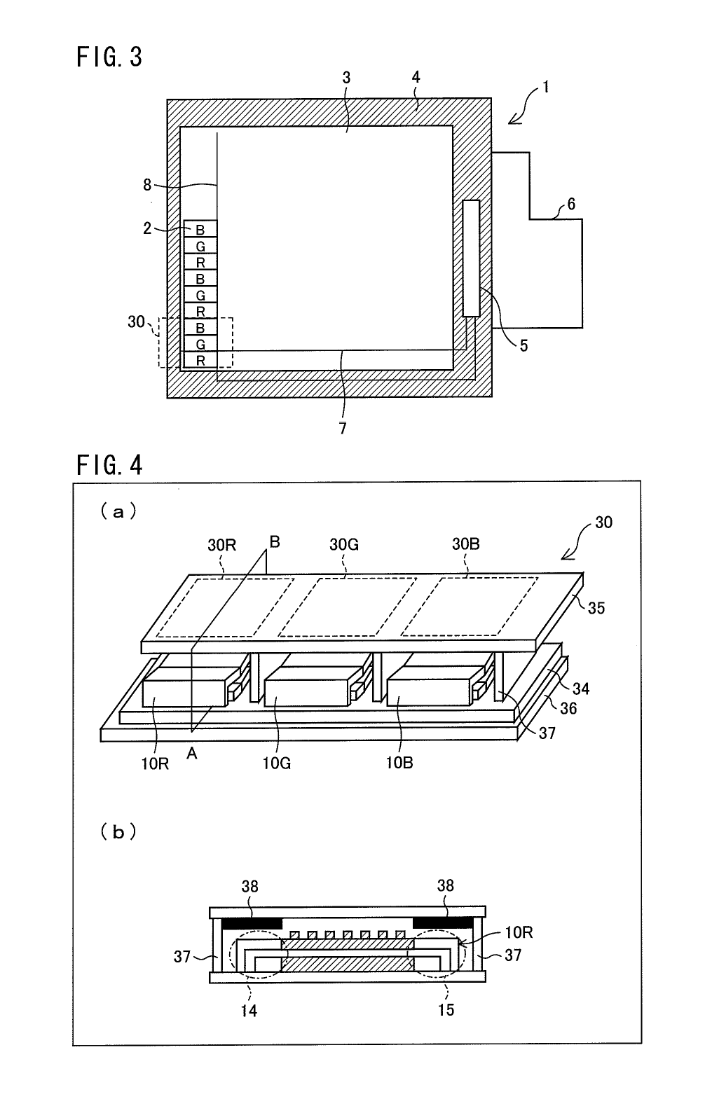

FIG. 3 is a view schematically illustrating a configuration of a principal mechanism of a display device of the present embodiment.

As illustrated in FIG. 3, a display device 1 (reflective display device) of the present embodiment includes a wavelength selective reflection element as a pixel 2, which wavelength selective reflection element takes in ambient light such as sunlight or indoor light and reflects light having a specific wavelength band. The pixel 2 can change a selected wavelength band depending on the design of the wavelength selective reflection element as later described, and serves as a red (R) pixel which reflects red light, green (G) pixel which reflects green light, or blue B (pixel) which reflects blue light. A display region 3 of the display device 1 has a plurality of pixels 2 arranged in matrix, in which a combination of R, G, and B serve as one unit.

The display region 3 is surrounded by a frame region 4, which frame region 4 has a drive IC 5 for providing ON/OFF signals to each of the pixels 2, and a FPC (Flexible Printed Circuits) 6.

The drive IC 5 includes a gate drive circuit and a source drive circuit. The gate drive circuit provides to the gate wire 7 a gate signal for selecting a pixel 2, and the source drive circuit provides to the source wire 8 a source signal for driving the pixel 2 based on an image signal, to control the ON/OFF state of each of the pixels 2 or a halftone display state. Moreover, the drive IC 5 is connected to an external circuit by the FPC 6, via an anisotropic conductive film.

(Configuration of Wavelength Selective Reflection Element)

The following description specifically explains the configuration of the wavelength selective reflection element constituting the pixel 2.

Illustrated in (a) and (b) of FIG. 1 are side views schematically illustrating a principal mechanism of the wavelength selective reflection element 10.

As illustrated in (a) and (b) of FIG. 1, the wavelength selective reflection element 10 includes: an upper transparent plate 12 (transparent plate) on which a guide-mode resonant grating 11 is formed; a lower transparent plate 13 (substrate) disposed facing the upper transparent plate 12; and MEMS switches 14 and 15 which are microelectromechanical systems, respectively provided on (i) a side of one edge of the upper transparent plate 12 and a corresponding one edge of the lower transparent plate 13 and (ii) a side of another edge of the upper transparent plate 12 and a corresponding another edge of the lower transparent plate 13 facing the one end of the upper transparent plate 12 and the corresponding one edge of the lower transparent plate 13. At least one of the MEMS switches 14 and 15 is driven to cause a change in a gap provided between the upper transparent plate 12 and the lower transparent plate 13.

The MEMS switch 14 includes a first electrode 14a provided on the upper transparent plate 12 side and a second electrode 14b provided on the lower transparent plate 13 side, and is configured so that a voltage is applied between the first electrode 14a and the second electrode 14b.

Similarly, the MEMS switch 15 includes a first electrode 15a provided on the upper transparent plate 12 side and a second electrode 15b provided on the lower transparent plate 13 side, and is configured so that a voltage is applied between the first electrode 15a and the second electrode 15b.

In FIG. 1, (a) illustrates a state in which the MEMS switches 14 and 15 are OFF, the upper transparent plate 12 and the lower transparent plate 13 have a gap formed therebetween, and reflected light is emitted. Illustrated in (b) of FIG. 1 is a state in which the MEMS switches 14 and 15 are switched ON, which causes the gap between the upper transparent plate 12 and the lower transparent plate 13 to be 0, and no reflective light is emitted therefrom.

According to this configuration, the upper transparent plate 12 and the lower transparent plate 13 are in contact with each other, without having any space therebetween from edge to edge thereof. Hence, different from the conventional configuration illustrated in FIG. 17 and FIG. 19, it is possible to achieve a change in reflectance from the edge to edge of the upper transparent plate 12.

When the state of the wavelength selective reflection element 10 is ON, the reflective light is emitted, as illustrated in (a) of FIG. 1, whereas when the state of the wavelength selective reflection element 10 is OFF, no reflective light is emitted, as illustrated in (b) of FIG. 1.

As illustrated in (a) and (b) of FIG. 1, the display device 1 including the wavelength selective reflection element 10 as the pixel 2, which wavelength selective reflection element is in an ON state when the MEMS switches 14 and 15 are OFF, emits reflective light while no voltage is applied to the pixel 2 and carries out white display on an entire display device 1. Hence, this display mode is normally white.

On the other hand, the configuration may be made so that no reflective light is emitted as illustrated in (b) of FIG. 1 when the MEMS switches 14 and 15 are OFF, and that the reflective light is emitted as illustrated in (a) of FIG. 1 when the MEMS switches 14 and 15 are ON. In this case, the display device 1 which includes the wavelength selective reflection element 10 as the pixel 2, which wavelength selective reflection element is in the OFF state when the MEMS switches 14 and 15 are OFF, emits no reflective light while no voltage is applied to the pixel 2, and carries out a black display on the entire display device 1. Hence, this mode is normally black.

The reflective display device of the normally white requires no application of a voltage to the MEMS switches 14 and 15 while the white display is carried out, and in a state in which a color display other than white is carried out, a voltage is just necessarily applied continuously to at least one of the MEMS switches 14 and 15 of the wavelength selective reflection element 10 that is to be switched OFF. Hence, it is possible to achieve low power consumption as compared to a conventional display device.

Moreover, the normally white is further advantageous in terms of power consumption as compared to normally black, in a case where the display device 1 is applied to use of, for example, electronic paper. This is because with electronic paper, black characters are mainly displayed on a white background, and thus an area of white display tends to be greater than an area of black display.

A drive mechanism of the MEMS switches 14 and 15 is not particularly limited since it is not an essential part of the present invention. However, the drive mechanism may be configured as follows for example. Application of a voltage between the first electrode 14a and the second electrode 14b causes the first electrode 14a and the second electrode 14b to be attracted to each other by static electricity. This causes the upper transparent plate 12 configured movable to be drawn towards the lower transparent plate 13 until the upper transparent plate 12 is in contact with the lower transparent plate 13. With this configuration, the first electrode 14a is connected to the upper transparent plate 12.

However, the upper transparent plate 12 may be fixed in position and the lower transparent plate 13 may be configured movable. In such a configuration, the second electrode 14b is connected to the lower transparent plate 13.

Transparent resin material such as acrylic resin, or transparent resin material used as an organic insulating film, or alternatively, non-conductive material such as SiO₂ may be used as forming material of the upper transparent plate 12. Out of these material, the transparent resin material can be easily processed and is easy to handle, and thus allows for easily forming the guide-mode resonant grating 11.

It is preferable that the lower transparent plate 13 is made of the same material as the upper transparent plate 12.

This configuration allows for preventing Fresnel reflection from occurring, which may occur in a case where the lower transparent plate 13 and the upper transparent plate 12 have a different refractive index. Accordingly, it is possible to increase the amount of light transmitted from the upper transparent plate 12 to the lower transparent plate 13 as much as possible, while the wavelength selective reflection element 10 is in the OFF state in which no light is reflected (black display of normally white or black display of normally black).

Even in a case where the upper transparent plate 12 and the lower transparent plate 13 have different refractive indices, it is preferable that the refractive index of the lower transparent plate 13 is within the following range: the refractive index of the upper transparent plate 12+0.5.

As such, according to the present invention, no large voltage is necessarily applied directly to the upper transparent plate 12 and the lower transparent plate 13; the gap between the upper transparent plate 12 and the lower transparent plate 13 can be adjusted by driving the MEMS switches 14 and 15 with a small voltage. Hence, it is possible to achieve low power consumption by the wavelength selective reflection element 10, and by the display device 1 including the wavelength selective reflection element 10.

The amount of power consumption of the display device 1 is far smaller than that of the display devices of Patent Literatures 1 through 3, and is around the same or reduced by few % as compared to that of a display device that uses a thin film transistor (TFT) as a switching element.

(Wiring Layout)

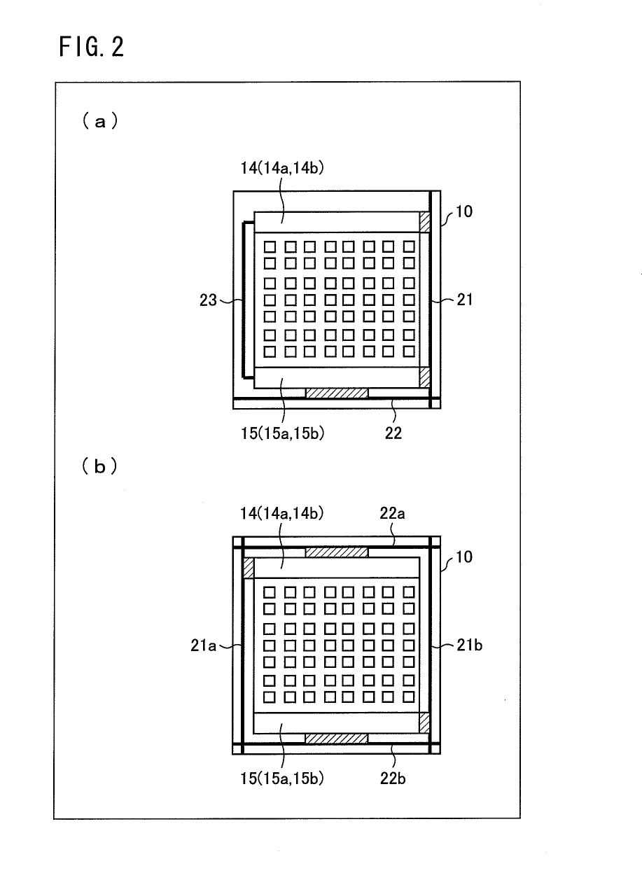

Illustrated in each of (a) and (b) of FIG. 2 is a plan view of a configuration in which MEMS electrode wires are disposed in the wavelength selective reflection element 10.

As illustrated in (a) of FIG. 2, a common lower MEMS electrode wire 21 is arranged to the MEMS switches 14 and 15, which MEMS switches are disposed on sides of the wavelength selective reflection element 10 in such a manner that the two MEMS switches face each other. The lower MEMS electrode wire 21 is connected to the second electrode 14b and the second electrode 15b, each of which is provided on the lower transparent plate 13 side. The lower MEMS electrode wiring 21 is one part of a gate wiring 7 illustrated in FIG. 3.

On the other hand, an upper MEMS electrode wire 22 is provided close to the MEMS switch 15, and is connected to the first electrode 15a provided on the upper transparent plate 12 side. The first electrode 15a is connected to the first electrode 14a provided on the upper transparent plate 12 side of the MEMS switch 14, via an inner wire 23. The upper MEMS electrode wire 22 is one part of a source wiring 8 illustrated in FIG. 3.

According to the configuration, the MEMS switches 14 and 15 are driven simultaneously.

On the other hand, (b) of FIG. 2 illustrates an arrangement of wires which allows for driving the MEMS switches 14 and 15 independently.

As illustrated in (b) of FIG. 2, the first electrode 14a and the second electrode 14b of the MEMS switch 14 are connected to the upper MEMS electrode wire 22a and the lower MEMS electrode wire 21a, respectively. Moreover, the first electrode 15a and the second electrode 15b of the MEMS switch 15 are connected to the upper MEMS electrode wire 22b and the lower MEMS electrode wire 21b, respectively.

The lower MEMS electrode wire 21a and the lower MEMS electrode wire 21b are each independently connected to the gate driving circuit, and the upper MEMS electrode wire 22a and the upper MEMS electrode wire 22b are each independently connected to the source driving circuit.

According to the configuration, it is possible to apply a voltage to the MEMS switches 14 and 15 at different timings, with use of different wires. The display device 1 which has the wavelength selective reflection element 10 having this configuration serve as its pixel is capable of carrying out halftone display. Descriptions of this will be provided later.

The wiring in the wavelength selective reflection element 10 is not limited to the foregoing arrangement. For example, even in a case where the second electrode 14b and the second electrode 15b provided on the lower transparent plate 13 side are connected to the common lower MEMS electrode wire 21, and the first electrode 15a and the second electrode 15b provided on the upper transparent plate 12 side are separately connected to the upper MEMS electrode wire 22a and the upper MEMS electrode wire 22b, respectively, it is possible to separately control the ON/OFF operations of the MEMS switches 14 and 15.

(Configuration of Wavelength Selective Reflection Unit)

As described with reference to FIG. 3, the following description explains a wavelength selective reflection unit 30 in which three wavelength selective reflection elements 10 are disposed as a horizontal line. The wavelength selective reflection elements 10 selectively reflect red light, green light, and blue light, respectively, so that color display in which a set of RGB serves as one unit can be carried out with a plurality of pixels 2.

Illustrated in (a) of FIG. 4 is a perspective view of a configuration of the wavelength selective reflection unit 30. Illustrated in (b) of FIG. 4 is a cross-sectional view of one pixel of the pixel 2 illustrated in FIG. 3, among the wavelength selective reflection unit 30.

As illustrated in (a) of FIG. 4, the wavelength selective reflection unit 30 has a red light emitting region 30R, a green light emitting region 30G, and a blue light emitting region 30B, which are provided with corresponding wavelength selective reflection elements 10R, 10G, and 10B, respectively. Light incident on the red light emitting region 30R, green light emitting region 30G, and blue light emitting region 30B are reflected respectively as a specific color selected depending on the wavelength selective reflection elements 10R, 10G, and 10B.

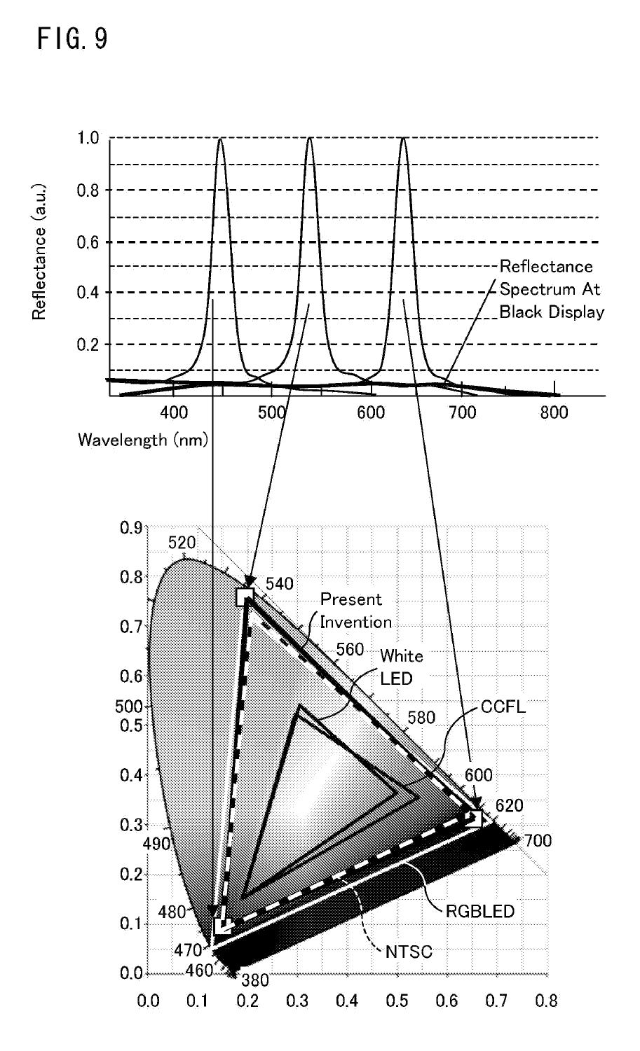

As shown in a conceptual view of a reflective light spectrum in FIG. 9, the wavelength selective reflection element 10R is formed so that it selectively reflects red light having a reflectance peak of around a wavelength of 630 nm; the wavelength selective reflection element 10G is formed so that it selectively reflects green light having a reflectance peak of around a wavelength of 530 nm, and a wavelength selective reflection element 10B is formed so that it selectively reflects blue light having a reflectance peak of around a wavelength of 450 nm.

The wavelength selective reflection elements 10R, 10G, and 10B are disposed as one horizontal line, and are sandwiched between two substrates 35 and 36. The substrate 35 disposed on a side on which light is reflected from the wavelength selective reflection elements 10R, 10G, and 10B is made of optically transparent material such as glass, quartz and plastic. Meanwhile, although the substrate 36 may be formed with the same material as the substrate 35, the substrate 36 does not necessarily need to be made of transparent material.

It is preferable that a light absorbing film 34 is formed on the substrate 36. With such a configuration, the light absorbing film 34 can absorb light that is not selectively reflected by the wavelength selective reflection elements 10R, 10G, and 10B.

For example, the surface of the light absorbing film 34 is formed having a fine bumpy shape, and as the light incident between separate projecting parts is repetitively reflected on walls of the projecting parts, the reflectance of the light continuously decreases. Moreover, a solar panel which converts optical energy into electric energy may be disposed instead of the light absorbing film 34. This allows for attaining energy saving, by converting light not reflected by the wavelength selective reflection elements 10R, 10G, and 10B into power and supplying this power while driving the wavelength selective reflection elements 10R, 10G, and 10B.

It is preferable that in the wavelength selective reflection unit 30, the partitions 37 are disposed between adjacent wavelength selective reflection elements 10R, 10G, and 10B. Moreover, as in (b) of FIG. 4 illustrating a section taken on A-B of the red light emitting region 30R illustrated in (a) of FIG. 4, it is preferable to form separate compartments of the wavelength selective reflection elements by disposing the partitions 37 on each of four sides of the wavelength selective reflection elements 10R, 10G, and 10B.

This prevents malfunctioning from occurring, of reflected light of a wavelength selective reflection element being incident on a wavelength selective reflection element adjacent to that wavelength selective reflection element. As a result, accuracy in luminance of the pixels 2 increases, which increases the quality of color display. Furthermore, since unnecessary light irradiation is held down, this also brings about an effect that contrast improves.

The partitions 37 at least require having light shielding properties, however it is not limited in any other way. However, it is more preferable if it also has a light absorbing function similar to the light absorbing plate 34.

Furthermore, as illustrated in (a) and (b) of FIG. 4, it is preferable that a light shielding film 38 is disposed lower than the transparent substrate 35 but upper of the MEMS switches 14 and 15, in the separate wavelength selective reflection element compartments. This configuration prevents light incident on a region not having the wavelength selecting function from being mixed in the reflected light as noise light.

(Principle of Operation of Wavelength Selective Reflection Element)

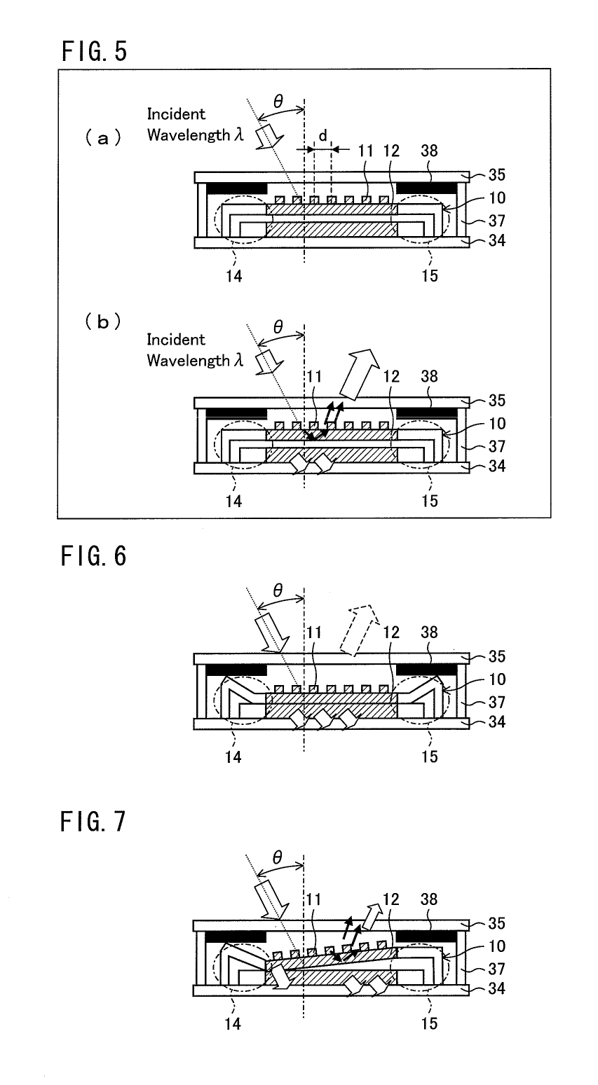

The following description explains a principle of operation of the wavelength selective reflection element 10, with reference to FIG. 5 and FIG. 6.

As illustrated in (a) of FIG. 5, by having, in the wavelength selective reflection element 10, a guide-mode resonant grating 11 be formed on the upper transparent plate 12 and a medium (e.g. air layer) be in contact with the guide-mode resonant grating 11 and the upper transparent plate 12 on their light incident side and on an opposite side thereof (on the lower transparent plate 13 side), just light having a wavelength λ (resonant wavelength) which satisfies the following phase matching condition, out of ambient light incident on the guide-mode resonant grating 11, is diffracted and propagated through the upper transparent plate 12. Note that the medium has a refractive index smaller than the refractive index of the guide-mode resonant grating 11 and that of the upper transparent plate 12. On the other hand, light having a wavelength other than the wavelength λ is transmitted through the upper transparent plate 12.

2π/λ×sin θ+m×2π/d=βs (1)

In the phase matching condition formula (I), θ is an incident angle of light incident on the guide-mode resonant grating 11, d is a base period of the diffraction grating formed as the guide-mode resonant grating 11, m is any integer, and βs is a propagation constant of light which propagates through the diffraction grating and is a constant dependent on the wavelength λ and a thickness of the upper transparent plate 12.

The light of the wavelength λ that is diffracted and is propagated through the upper transparent plate 12 is discharged outside the upper transparent plate 12 again due to the guide-mode resonant grating 11. In a case where the phase matching condition matches, the light having the wavelength λ discharged to the side on which ambient light is incident out of the discharged light strengthens each other by interference, since the phases match.

On the other hand, the light having the wavelength λ that is discharged on the lower transparent plate 13 weakens each other in a case where the phase matching condition is satisfied, since the phases are 180° opposite each other.

The light of the wavelength λ which satisfies the phase matching condition is emitted in various angles from various positions of the upper transparent plate 12. Hence, the light finally reflected outside the wavelength selective reflection element 10 becomes light that has no angle dependency. This allows for achieving a sufficient range of a viewing angle capable of viewing optimum display, to a degree as with a regular display.

When the MEMS switches 14 and 15 are switched OFF as illustrated in (b) of FIG. 5, an air layer is present between the upper transparent plate 12 and the lower transparent plate 13. With such a principle, the light having the wavelength λ out of ambient light is reflected with a reflectance substantially close to 100%. In this state, a proportion of Fresnel reflection (a reflection occurring to a portion of light when light is incident on a boundary surface on which substances having different refractive indices are in contact with each other) is approximately 2%. Hence, this is thought to be contributive to the improvement in contrast of the display device 1.

Moreover, out of the ambient light, the light other than the light having the wavelength λ is transmitted through the upper transparent plate 12 and the lower transparent plate 13, and is absorbed by the light absorbing film 34.

On the other hand, as illustrated in FIG. 6, when the MEMS switches 14 and 15 are switched ON, the upper transparent plate 12 and the lower transparent plate 13 are in contact with each other, so therefore light that satisfies the phase matching condition is not generated. Hence, ambient light incident on the guide-mode resonant grating 11 is transmitted through the upper transparent plate 12 and the lower transparent plate 13, and is absorbed by the light absorbing film 34.

As described above, a value of the gap between the upper transparent plate 12 and the lower transparent plate 13 do not largely give effect on the display. Hence, it is unnecessary to strictly control the value of the gap.

(Operation 1 of Wavelength Selective Reflection Unit)

The wavelength selective reflection unit 30 illustrated in FIG. 4 has its base period d of the guide-mode resonant grating 11 provided in the wavelength selective reflection elements 10R, 10G, and 10B, appropriately designed. Hence, the wavelength selective reflection elements 10R, 10G, and 10B can substantially reflect all of respective red light, green light, and blue light out of the ambient light.

If all of the wavelength selective reflection elements 10R, 10G, and 10B are in the state illustrated in (b) of FIG. 5, this is in an ON state as the pixel 2, and the wavelength selective reflection unit 30 displays white as a whole.

If all of the wavelength selective reflection elements 10R, 10G, and 10B are as in the state illustrated in FIG. 6, this is in an OFF state as the pixel 2, and the wavelength selective reflection unit 30 displays black as a whole.

Moreover, by combining the ON and OFF of the MEMS switches 14 and 15 of the wavelength selective reflection elements 10R, 10G, and 10B, it is possible to adjust the displayed color of the wavelength selective reflection unit 30.

Moreover, as seen in the conceptual reflected light spectrum of the wavelength selective reflection unit 30 illustrated in FIG. 9, a wavelength distribution of reflected light generated by the guide-mode resonant grating shows a half bandwidth of approximately 20 nm to 30 nm for each color, and shows that color purity thereof is extremely high.

Hence, it is possible to achieve color reproductivity with a broad displayable color gamut and with a NTSC ratio near 100%, as in FIG. 9 in which a color gamut of the wavelength selective reflection unit 30 is shown in a chromaticity diagram as a triangle with three white squares serving as tips thereof.

Moreover, as shown in the conceptual reflectance spectrum at a time of black display in FIG. 9, wavelength distribution of reflected light show a flat small value throughout the wavelengths. Hence, it is possible to achieve a good black display.

(Operation 2 of Wavelength Selective Reflection Unit: Display Mode of Halftone)

FIG. 7 is a view schematically illustrating a state of the wavelength selective reflection element 10 when halftone is displayed.

As illustrated in FIG. 7, when the wavelength selective reflection element 10 displays halftone, one of the MEMS switches 14 and 15 is switched ON, and the other one thereof is switched OFF. For instance, when the MEMS switch 14 is switched ON, the upper transparent plate 12 and the lower transparent plate 13 are in contact with each other on the side which the MEMS switch 14 is provided. As a result, the phase matching condition is not satisfied, thereby preventing the occurrence of resonance caused by the interference of diffraction light and transmitted light. In this case, incident light having an incident angle of θ is absorbed by the light absorbing film 34, which incident light passes through the lower transparent plate 13.

On the other hand, on the side on which the MEMS switch 15 is provided, an air layer is present between the upper transparent plate 12 and the lower transparent plate 13. This allows for satisfying the phase matching condition, thereby causing the resonance caused by the interference of the diffraction light and the transmission light to occur. Hence, just the light having the wavelength λ is reflected among the incident light having an incident angle of θ, and light other than the light having the wavelength λ is absorbed by the light absorbing film 34 upon passing through the lower transparent plate 13. This allows for reducing the reflectance of the light having the wavelength λ of the wavelength selective reflection element 10 to approximately 50%. As a result, the wavelength selective reflection element 10 can display the halftone.

The display device 1 of the present embodiment 1 can display a halftone image by controlling the ON and OFF of the MEMS switches 14 and 15 in the wavelength selective reflection elements 10R, 10G, and 10B, by combining any one of the states illustrated in (b) of FIG. 5, FIG. 6, and FIG. 7. Moreover, by setting the reflectance of the light having the wavelength λ of the wavelength selective reflection elements 10R, 10G, and 10B to be any one of 0%, 50%, and 100% as appropriate, it is possible to further display various colors as compared to setting this to either one of 0% or 100%.

(Another Configuration Allowing Halftone Display)

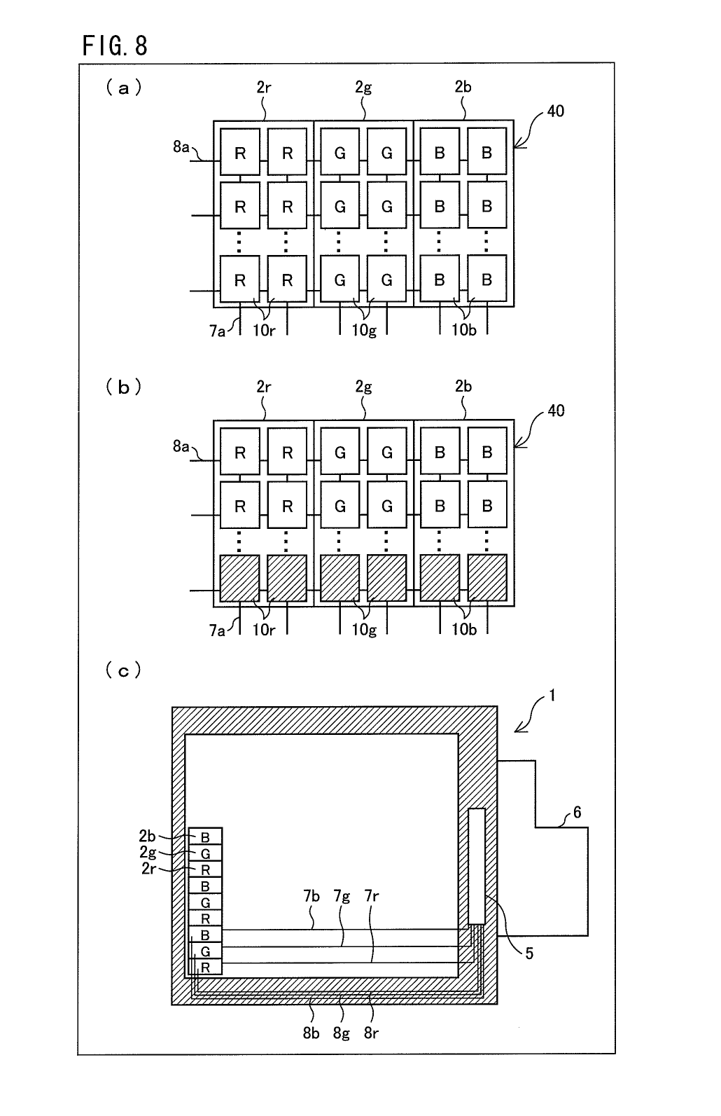

Another configuration which is capable of halftone display of another stage to the display device 1, that is to say, gradation display, is described with reference to (a) and (b) of FIG. 8.

Illustrated in each of (a) and (b) of FIG. 8 is a plan view schematically illustrating a configuration of a picture element in which R pixel 2r, G pixel 2g, and B pixel 2b serve as one set.

As illustrated in (a) of FIG. 8, the R pixel 2r includes a plurality of wavelength selective reflection elements 10r, each of which has a configuration similar to the wavelength selective reflection element 10 and selectively reflects red light. The plurality of wavelength selective reflection elements 10r are disposed so that two wavelength selective reflection elements 10r are horizontally aligned in one row, and that two or more rows are provided. This forms a red light selective reflection unit.

The same applies with the G pixel 2g and the B pixel 2b. The wavelength selective reflection elements 10g which selectively reflect green light are disposed so that two wavelength selective reflection elements 10g are horizontally aligned in one row, and that two or more rows are provided, whereby forming a green light selective reflection unit, and the wavelength selective reflection elements 10b each of which selectively reflects blue light are disposed so that two wavelength selective reflection elements 10b are horizontally aligned in one row, and that two or more rows are provided, whereby forming a blue light selective reflection unit.

Moreover, the light selective reflection unit of each of the colors is wired with gate wires 7a and source wires 8a. For example, as illustrated in (a) of FIG. 8, the gate wires 7a are wired so that one wire is associated with the wavelength selective reflection element 10r aligned in one column, to simultaneously supply a gate signal to the wavelength selective reflection elements 10r aligned in that one column.

Moreover, the source wires 8a are wired so that one wire is associated with the wavelength selective reflection elements 10r, 10g, and 10b aligned in one row, to simultaneously supply a source signal to the wavelength selective reflection elements 10r, 10g, and 10b aligned in that one row.

With such wiring, it is possible to supply a source signal to one of a plurality of wavelength selective reflection elements in one row selected simultaneously by the gate signal, in the light selective reflection unit of its respective color.

It is preferable that partitions similar to the partitions 37 illustrated in FIG. 4 are provided on each of four sides of the red light selective reflection unit, green light selective reflection unit, and blue light selective reflection unit, to form a compartment for each of the light selective reflection units of its respective color.

Moreover, in each of the light selective reflection units of its respective color, a region which does not have the wavelength selecting function is formed in a grid-like fashion. Accordingly, it is preferable that a light-shielding film similar to the light-shielding film 38 illustrated in (b) of FIG. 4 is formed in the grid-like fashion, so that it is possible to prevent light from being incident on that region and be mixed into the reflected light as noise light.

As such, one picture element is constituted of a wavelength selective reflection unit 40 in which the red light selective reflection unit, the green light selective reflection unit, and the blue light selective reflection unit are disposed in one horizontal line.

According to the configuration, it is possible to carry out halftone display of gray scale (shades of monochrome) and color, by adjusting an area on which the reflected light of a specific color is obtained, in each of the R pixel 2r, G pixel 2g, and B pixel 2b.

More specifically, the halftone display of gray scale and color can be accomplished by controlling a ratio of ON and OFF of the plurality of wavelength selective reflection elements disposed in the light selective reflection units of its respective color. Note that the number of the light selective reflection units of its respective color and the number of the disposed wavelength selective reflection elements are determined in accordance with the number of gray scales that is desirably displayed. Namely, in a case where a display of n gray scale is desirably displayed on the light selective reflection units of a respective color, the number of the plurality of wavelength selective reflection elements disposed in the light selective reflection unit of a respective color is to be set as n−1.

Below explains one example of the gradation display. As illustrated in (a) of FIG. 8, when all of a plurality of wavelength selective reflection elements 10r, 10g, and 10b disposed in the light selective reflection units of respective colors are in the ON state (all MEMS switches are OFF), the wavelength selective reflection unit serving as one picture element display can display white display.

Moreover, as illustrated in FIG. 8(b), in the light selective reflection units of respective colors, a portion of the wavelength selective reflection elements may be made in the OFF state to display black, and light emitting areas of red light, green light, and blue light are changeable by having a part of the wavelength selective reflection elements be in the ON state. This allows for changing the gradation in multiple stages.

In order to change the gradation in the foregoing method, each of the wavelength selective reflection elements 10r, 10g, and 10b require being driven by high speed. The wavelength selective reflection elements to be switched ON and OFF are determined while selecting the gate wires 7a and the source wires 8a in time division. At this time, the driving frequency becomes the number of divisions of regular driving frequencies×each pixel (i.e. the number of wavelength selective reflection elements 10r). Hence, it is preferable to have a D/A converter provided with the source wiring and the gate wiring, for achieving low power consumption.

Moreover, the driving frequency may be reduced by controlling the ON and OFF of parallel wavelength selective reflection elements (sub-pixels) upon increasing the number of signal wires.

For instance, the wavelength selective reflection elements 10r, 10g, and 10b aligned in one row is not associated with one source wire 8a as illustrated in (a) of FIG. 8, but a source wire is associated individually to each of the R pixel 2r, G pixel 2g, and B pixel 2b, as illustrated in (c) of FIG. 8. For example, a source wire 8r is disposed to the R pixel 2r, a source wire 8g is disposed to the G pixel 2g, and a source wire 8b is disposed to the B pixel 2b.

This allows for supplying a gate signal to the gate wire 7r for selecting one column of the wavelength selective reflection element 10r aligned in the R pixel 2r, whereby allowing for supplying a source signal to the source wire 8r for driving the wavelength selective reflection element 10r of one row aligned in the R pixel 2r, based on an image signal. Hence, it is possible to control the ON/OFF state or the halftone display state of the R pixel 2r by use of a low driving frequency.

Moreover, in order to reduce the driving frequency, it is possible to dispose the gate wire and the source wire to each of the wavelength selective reflection elements 10r, 10g, and 10b included in each pixel. For example, a gate wire 7r and a source wire 8r are disposed in the wavelength selective reflection element 10r. The same applies with the wavelength selective reflection element 10g and the wavelength selective reflection element 10b.

Since the number of wires becomes large in number in the former and latter cases of the foregoing wiring mode, it is preferable that the wires are provided in multiple layers.

(Production Steps of Guide-Mode Resonant Grating)

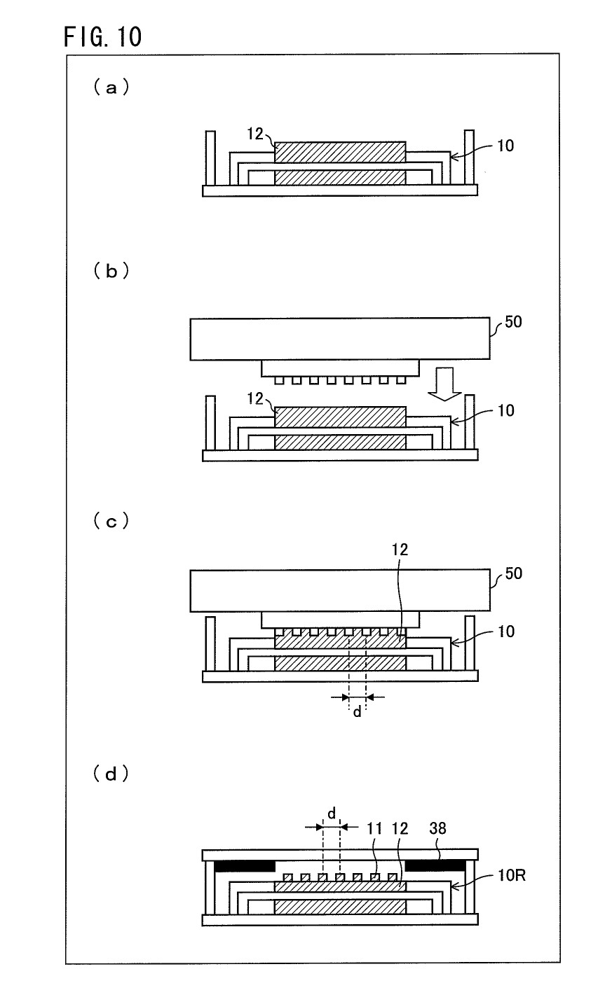

Illustrated in (a) to (d) of FIG. 10 are process drawings showing steps for producing a guide-mode resonant grating 11 of the wavelength selective reflection element 10.

Formation of a fine structure is required for preparing the guide-mode resonant grating 11. The formation of the fine structure is suitably carried out by a processing method called thermal nanoimprint.

The thermal nanoimprint is a processing method in which a heated mold having a bumpy pattern formed thereon in nanoscale is pressed onto a thermoplastic resin layer and is taken off upon cooling the thermoplastic resin layer, to transfer the bumpy pattern onto the thermoplastic resin layer. The following description explains this in detail.

As illustrated in (a) of FIG. 10, the wavelength selective reflection element 10 is first prepared. A transparent thermoplastic resin with environmental resistance is preferably used as the upper transparent plate 12, and acrylic resin, polycarbonate, or the like may be used.

Next, as illustrated in (b) and (c) of FIG. 10, a heated mold 50 is pressed onto a surface of the upper transparent plate 12 for a predetermined time. For example, a temperature is set as around 150° C. and a predetermined time is set as approximately 30 minutes. The conditions of the temperature and the predetermined time changes based on the state of the mold and the type of resin.

The mold 50 is prepared by use of Ni electroforming, and a diffraction grating pattern having the base period d as described above is formed. This allows for neatly transferring the diffraction grating pattern formed on the mold 50 to the upper transparent plate 12.

Finally, as illustrated in (d) of FIG. 10, after the upper transparent plate 12 is cooled down, the mold 50 is taken off.

By carrying out the steps as described above, the guide-mode resonant grating 11 is formed on the upper transparent plate 12.

### Embodiment 2

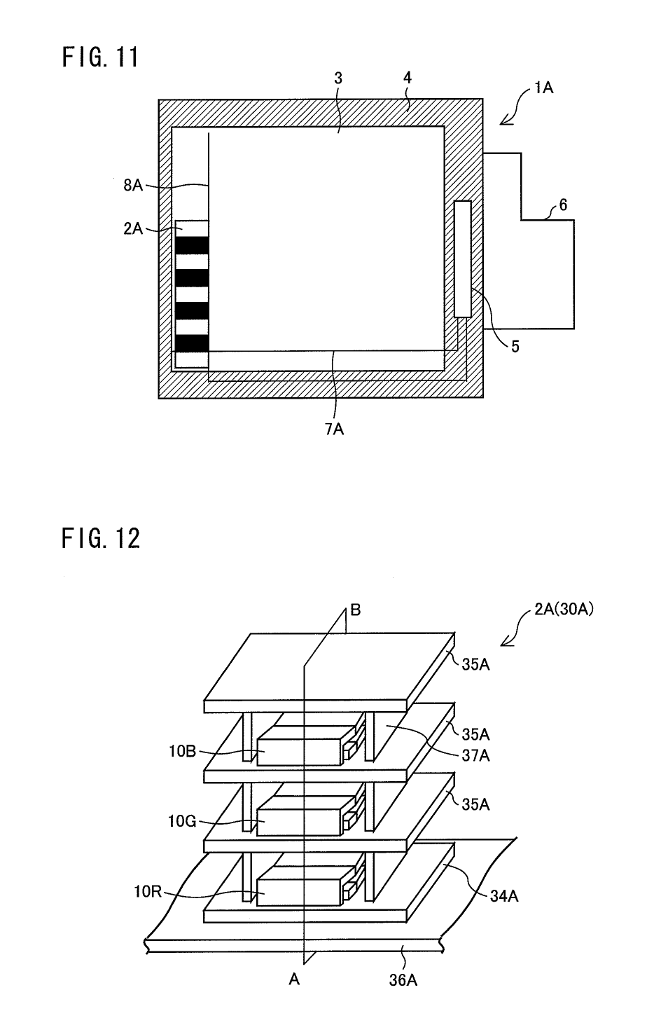

Described below is another embodiment related to the present invention display device, with reference to FIG. 11 to FIG. 15.

For convenience in explanation, members having identical functions as those in the drawings described in Embodiment 1 are provided with identical reference signs, and descriptions thereof have been omitted.

(Principal Part of Display Device)

FIG. 11 is a view schematically illustrating a configuration of a principal mechanism of a display device 1A according to the present embodiment 2.

As illustrated in FIG. 11, a display region 3 of the display device 1A has a plurality of pixels 2A be aligned in matrix. However, each of the pixels 2A is configured so that a R pixel, a G pixel, and a B pixel are stacked vertically on top of each other. Moreover, a gate wire 7A which supplies a gate signal to the pixels 2A includes separate gate wires corresponding to respective ones of the R pixel, G pixel, and B pixel, and a source wire 8A which supplies a source signal to the pixels 2A include separate source wires corresponding to respective ones of the R pixel, G pixel, and B pixel.

(Pixel Arrangement)

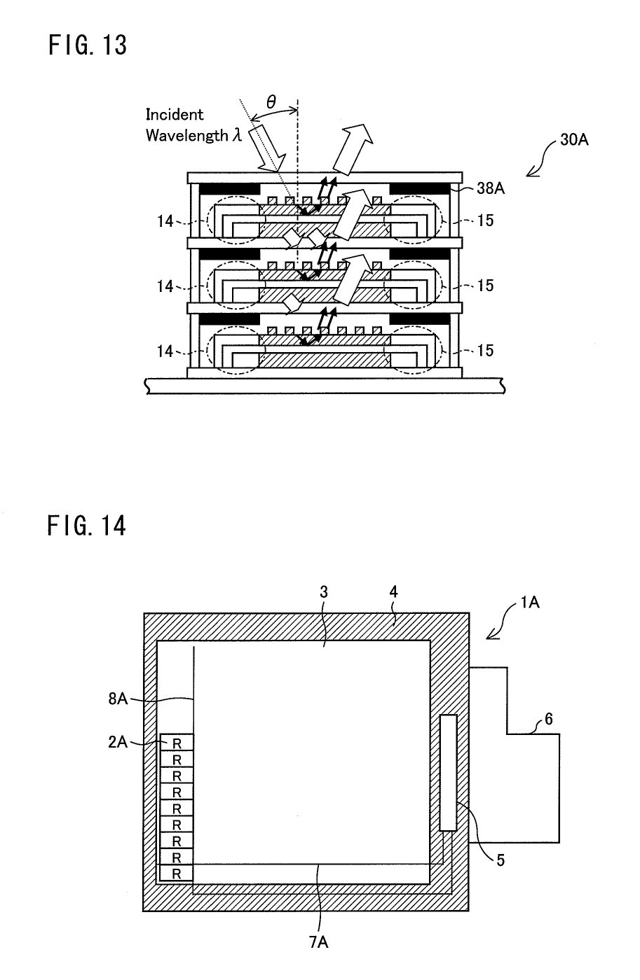

FIG. 12 is a perspective view illustrating an arrangement of the pixel 2A. FIG. 13 is a cross-sectional view taken on A-B illustrated in FIG. 12, and is a cross-sectional view illustrating a wavelength selection operation of the pixel 2A.

As illustrated in FIG. 12 and FIG. 13, the pixel 2A is configured as a wavelength selective reflection unit 30A in which the wavelength selective reflection elements 10R, 10G, and 10B are stacked vertically on top of each other.

The wavelength selective reflection element 10B of an uppermost layer and the wavelength selective reflection element 10G of a middle layer are each sandwiched between respective substrates 35A similar to the substrate 35 ((a) of FIG. 4). Namely, the substrates 35A are made of an optically transparent material such as glass, quartz, or plastic.

The wavelength selective reflection element 10R of a lowermost layer has, on its bottom side, a substrate 36A similar to the substrate 36. It is preferable that a light absorbing film 34A similar to the light absorbing film 34 is formed between the wavelength selective reflection element 10R and the substrate 36A.

Moreover, it is preferable to form separate compartments for the wavelength selective reflection elements by providing partitions 37A similar to the partitions 37 to each of the four sides of the wavelength selective reflection elements 10R, 10G, and 10B.

Furthermore, it is preferable that in the separate compartments of the wavelength selective reflection elements, a light shielding film 38A similar to the light shielding film 38 is disposed on a lower side of the transparent substrate 35A but on an upper side of the MEMS switches 14 and 15.

(Operations of Wavelength Selective Reflection Unit)

In FIG. 13, each of the wavelength selective reflection elements 10R, 10G, and 10B are in the ON state in which light having a specific wavelength is selectively reflected. When ambient light is incident on the wavelength selective reflection element 10B of the uppermost layer in this state, the wavelength selective reflection element 10B, while selectively reflecting blue light with a reflectance of substantially 100%, causes light other than the blue light to transmit through the wavelength selective reflection element 10B. Namely, the light other than the blue light is incident on the wavelength selective reflection element 10G of the middle layer, by passing through a transparent substrate 35A.

The wavelength selective reflection element 10G, while selectively reflecting green light among received light with a reflectance of substantially 100%, causes the remaining light to transmit through the wavelength selective reflection element 10G. The reflected green light is emitted outside the wavelength selective reflection unit 30A by being transmitted through the wavelength selective reflection element 10G. Moreover, the remaining light is incident on the wavelength selective reflection element 10R of the lowermost layer, by the remaining light being passed through a transparent substrate 35A.

The wavelength selective reflection element 10R, while selectively reflecting red light from among the remaining light with a reflectance of substantially 100%, causes light which finally remain thereafter to be transmitted through the wavelength selective reflection element 10R. The reflected red light is transmitted through the wavelength selective reflection elements 10G and 10B, and is emitted outside the wavelength selective reflection unit 30A. The light finally remaining is absorbed by the light absorbing film 34A and disappears, or if a solar cell panel is used as the light absorbing film 34A, the remaining light is converted into power.

The wavelength selective reflection unit 30A illustrated in FIG. 13 achieve the reflectance of substantially 100% for each of the wavelength selective reflection elements 10R, 10G, and 10B, when the MEMS switches 14 and 15 are all in the OFF state. This allows for carrying out white display having high luminance.

Moreover, in a case where the wavelength selective reflection element 10B of the uppermost layer and the wavelength selective reflection element 10G of the center layer have their MEMS switches 14 and 15 switched ON, whereby the wavelength selective reflection element 10B of the uppermost layer and the wavelength selective reflection element 10G of the middle layer generate no reflected light, just the wavelength selective reflection element 10R of the lowermost layer selectively reflects the red light. In this case, the wavelength selective reflection unit 30A is a red-colored pixel.

FIG. 14 illustrates a state in which all of the pixels 2A are the red-colored pixel as described above.

Moreover, by combining the ON and OFF state of each of the wavelength selective reflection elements 10R, 100, and 10B as appropriate, it is possible to display various colors. Furthermore, as described with reference to FIG. 7, by controlling so that just one of the MEMS switches 14 and 15 is switched ON, it is possible to achieve a halftone display state or further display various colors.

(Another Configuration Allowing Halftone Display)

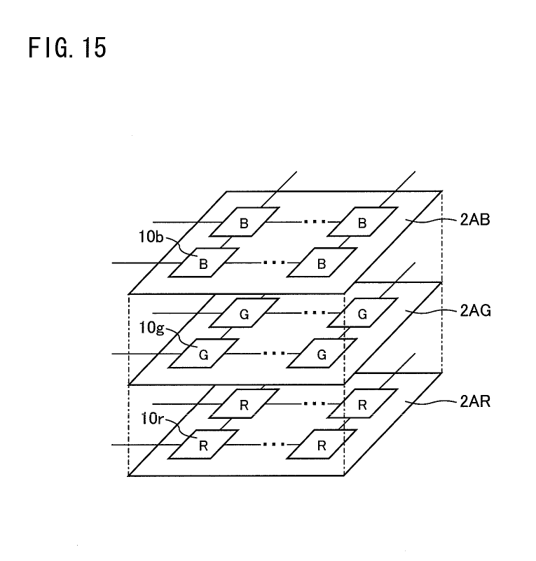

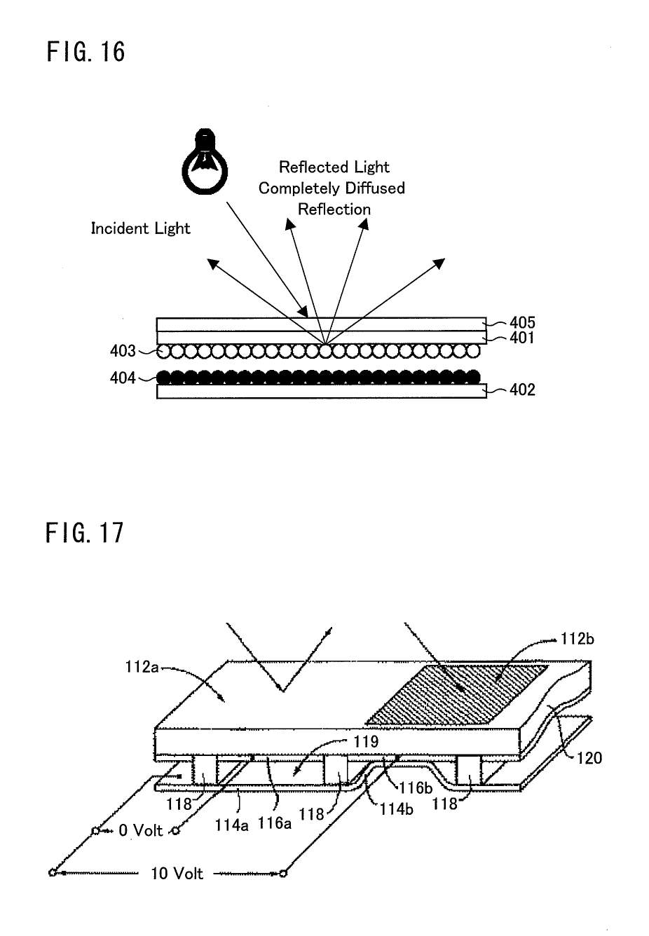

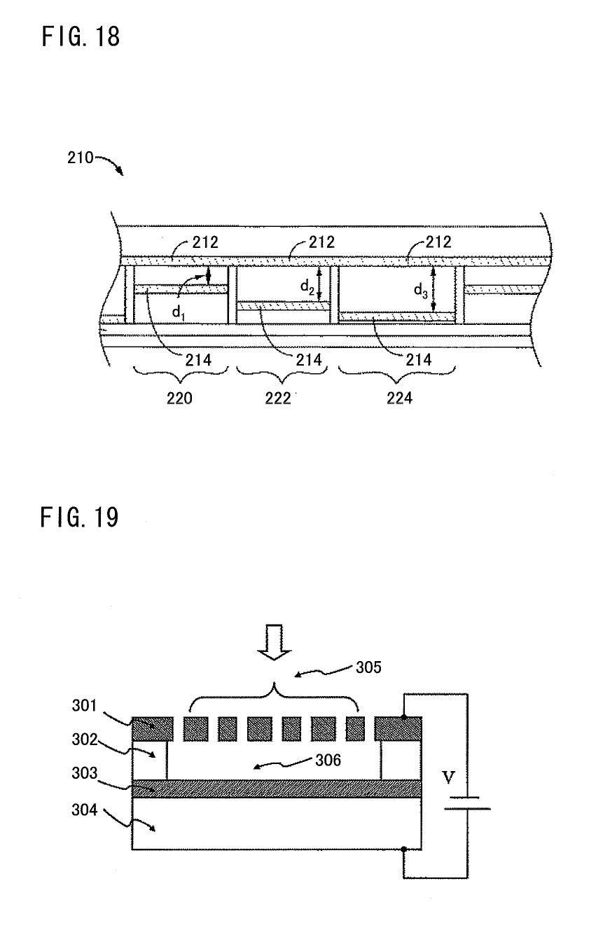

FIG. 15 is a perspective view illustrating a modified mode of the configuration of the R pixel, G pixel, and B pixel, so that the wavelength selective reflection unit 30A having the stacked arrangement of the wavelength selective reflection elements can further carry out gradation display of multiple stages.

For example, similarly with the R pixel 2a described with reference to (a) of FIG. 8, the R pixel 2AR includes a plurality of the wavelength selective reflection elements 10r which selectively reflect red light. The plurality of wavelength selective reflection elements 10r are disposed so that two wavelength selective reflection elements 10r are horizontally aligned in one row, and that two or more rows are provided. This forms a red light selective reflection unit.

The same applies with the G pixel 2AG and B pixel 2AB. The wavelength selective reflection elements 10g which selectively reflect green light are disposed so that two wavelength selective reflection elements 10g are horizontally aligned in one row and that two or more rows are provided, whereby forming a green light selective reflection unit, and the wavelength selective reflection elements 10b each of which selectively reflects blue light are disposed so that two wavelength selective reflection elements 10b are horizontally aligned in one row, and that two or more rows are provided, whereby forming a blue light selective reflection unit.

It is as already described that halftone of gray scale (shades of monochrome) and color is displayable with the configuration as described above, by adjusting the area on which reflected light of a specific color is obtained in each of the R pixel 2AR, G pixel 2AG, and B pixel 2AB.

Moreover, the spectral characteristics and color gamut of the wavelength selective reflection unit 30A are also similar as the wavelength selective reflection unit 30. Pure color properties of each of the colors are high, a displayable color gamut is broad, and a good light reproducibility and contrast can be achieved.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

It is preferable that the wavelength selective reflection element of the present invention is configured in such a manner that each of the MEMS includes: a first electrode provided on a side on which the transparent plate is disposed; and a second electrode provided on a side on which the substrate is disposed, the first electrode and the second electrode being disposed so that a voltage is applied therebetween.

According to the configuration, the MEMS can be operated and a gap between the transparent plate and the substrate can be adjusted by applying a voltage between the first electrode and the second electrode.

The configuration may be made so that the transparent plate moves towards the substrate, or conversely, so that the substrate moves towards the transparent plate.

It is preferable that in the wavelength selective reflection element of the present invention, the substrate is transparent.

This allows for the substrate to reflect light of a specific wavelength band (S1) selected by guide-mode resonant grating while causing light having a wavelength band (S2) other than the specific wavelength band to be transmitted through the substrate. If the substrate is not transparent, it is not possible to take out the light of the wavelength band (S2) from the wavelength selective reflection element. However, with the configuration described above, it is possible to take out and use the light of the wavelength band (S2) from the wavelength selective reflection element through the substrate.

It is preferable that in the wavelength selective reflection element of the present invention, the first electrode of one of the MEMS is electrically connected to the first electrode of the other one of the MEMS, and the second electrode of the one of the MEMS is electrically connected to the second electrode of the other one of the MEMS.

According to the configuration, a voltage can be applied simultaneously to the first electrode and the second electrode of the two MEMS. Hence, it is possible to simultaneously drive two MEMS.

It is preferable in the wavelength selective reflection element of the present invention that the voltage be applied to a pair of the first electrode and the second electrode of one of the MEMS through a wire different from a wire for applying the voltage to a pair of the first electrode and the second electrode of the other one of the MEMS.

According to the configuration, it is possible to apply a voltage to the first electrode and the second electrode of the two MEMS through different wires and in different timings. As already described, this allows for changing the gap in a state in which the substrate is tilted with respect to the transparent plate. Hence, it is possible to obtain a reflectance of an intermediate value between the minimum value and the maximum value.

A display device having a wavelength selective reflection element of this configuration serve as a pixel is capable of displaying halftone.

A wavelength selective reflection unit of the present invention includes: the wavelength selective reflection element formed so that the guide-mode resonant grating selectively reflects red light; the wavelength selective reflection element formed so that the guide-mode resonant grating selectively reflects green light; and the wavelength selective reflection element formed so that the guide-mode resonant grating selectively reflects blue light, the three wavelength selective reflection elements being disposed horizontally in one line.

According to the configuration, it is possible to diversely change a mixture ratio of the reflected red light, green light, and blue light, by controlling the driving of the MEMS disposed on each of the wavelength selective reflection elements. As a result, it is possible to adjust the color reflected, in the wavelength selective reflection unit.

Moreover, a display device whose picture element is the wavelength selective reflection unit is capable of carrying out full color display.

Moreover, the guide-mode resonant grating has a feature that a selected wavelength band is narrow. Hence, the spectra of the red light, green light, and blue light, each of which are reflected from the wavelength selective reflection unit, are each a narrow band, and thus have high color purity. Therefore, a reflective display device including the wavelength selective reflection unit as a picture element can achieve a broad color gamut having high color purity for each color and a NTSC ratio of near 100%.

It is preferable that in the wavelength selective reflection unit of the present invention, the wavelength selective reflection elements be partitioned by light shielding walls disposed between adjacent ones of the wavelength selective reflection elements.

With the configuration, it is possible to prevent a malfunction that reflected light of a wavelength selective reflection element is incident on an adjacent wavelength selective reflection element. This improves the accuracy in luminance of the wavelength selective reflection element. As a result, quality of color display is improved on the display device whose picture element is the wavelength selective reflection unit, and no unnecessary light is emitted from the wavelength selective reflection element. Hence, this allows for improving contrast of the display device.

A wavelength selective reflection unit of the present invention includes: the wavelength selective reflection element formed so that the guide-mode resonant grating selectively reflects red light; the wavelength selective reflection element formed so that the guide-mode resonant grating selectively reflects green light; and the wavelength selective reflection element formed so that the guide-mode resonant grating selectively reflects blue light, the three wavelength selective reflection elements being stacked vertically on top of each other, wherein the substrate included in each of the wavelength selective reflection elements is transparent.

According to the configuration, the substrate of each of the wavelength selective reflection elements is transparent, so light having the wavelength band (S2), which light has passed through a first wavelength selective reflection element positioned on the top of the stacked wavelength selective reflection elements, is incident on a second wavelength selective reflection element positioned in the middle of the stacked wavelength selective reflection elements.

The second wavelength selective reflection element selectively reflects light having a different wavelength band (S3) from the wavelength band (S1) reflected by the first wavelength selective reflection element, and causes light of a wavelength band (S4) other than the wavelength band (S3) to be incident on a third wavelength selective reflection element positioned on the bottom of the stacked wavelength selective reflection elements. Finally, the third wavelength selective reflection element selectively reflects light of the wavelength band (S4).

Each of the light selectively reflected by its corresponding wavelength selective reflection elements is emitted in a mixed state from the wavelength selective reflection unit, i.e., from the first wavelength selective reflection element positioned on the top.

As such, by controlling the driving of the MEMS disposed on each of the wavelength selective reflection elements, it is possible to diversely change a mixture ratio of the reflected red light, green light, and blue light. As a result, it is possible to adjust the color to be reflected in the wavelength selective reflection unit.

Moreover, a display device whose wavelength selective reflection unit serves as a picture element is capable of carrying out a full color display.

Furthermore, the guide-mode resonant grating has a feature that a selected wavelength band is narrow. Hence, the spectra of the red light, green light, and blue light that are reflected from the wavelength selective reflection unit are each a narrow band, and thus have high color purity. Consequently, a reflective display device including the wavelength selective reflection unit as a picture element can achieve a broad color gamut having high color purity for each color and a NTSC ratio of near 100%.

Out of the wavelength selective reflection elements stacked vertically on top of each other, the substrate of the wavelength selective reflection element of the lowermost layer may also be opaque.

A wavelength selective reflection unit of the present invention includes: a red light selective reflection unit in which the wavelength selective reflection elements are disposed therein so as to include two wavelength selective reflection elements in one row and have at least two rows thereof, formed so that the guide-mode resonant grating selectively reflects red light; a green light selective reflection unit in which the wavelength selective reflection elements are disposed therein so as to include two wavelength selective reflection elements in one row and have at least two rows thereof, formed so that the guide-mode resonant grating selectively reflects green light; and a blue light selective reflection unit in which the wavelength selective reflection elements are disposed therein so as to include two wavelength selective reflection elements in one row and have at least two rows thereof, formed so that the guide-mode resonant grating selectively reflects blue light, the red light selective reflection unit, the green light selective reflection unit, and the blue light selective reflection unit being disposed horizontally in one line.

According to the configuration, it is possible to diversely change reflected areas of each of red light, green light, and blue light, by controlling the driving of each of wavelength selective reflection elements in the red light selective reflection unit, green light selective reflection unit, and the blue light selective reflection unit. This allows for a more tiny alteration in gradation.

Moreover, a display device whose wavelength selective reflection unit serves as a picture element is capable of carrying out high quality full color display.

The wavelength selective reflection unit of the present invention includes: a red light selective reflection unit in which the wavelength selective reflection elements are disposed therein so as to include two wavelength selective reflection elements in one row and have at least two rows thereof, formed so that the guide-mode resonant grating selectively reflects red light; a green light selective reflection unit in which the wavelength selective reflection elements are disposed therein so as to include two wavelength selective reflection elements in one row and with at least two rows thereof, formed so that the guide-mode resonant grating selectively reflects green light; and a blue light selective reflection unit in which the wavelength selective reflection elements are disposed therein so as to include two wavelength selective reflection elements in one row and have at least two rows thereof, formed so that the guide-mode resonant grating selectively reflects blue light, the red light selective reflection unit, the green light selective reflection unit, and the blue light selective reflection unit being stacked vertically on top of each other.

According to the configuration, the substrate in each of the wavelength selective reflection elements is transparent. Hence, as already described, it is possible to diversely change the mixture ratio of the reflected red light, green light, and blue light, similarly with the wavelength selective reflection unit in which the substrates are transparent and the wavelength selective reflection elements selectively reflecting light of different colors are stacked vertically on top of each other, and further diversely change the reflected areas of the red light, green light, and blue light. This allows for displaying a more tiny alteration in gradation.

Moreover, a display device whose wavelength selective reflection unit serves as a picture element can achieve a full color high quality display.

Out of the wavelength selective reflection elements stacked vertically on top of each other, the substrate of the wavelength selective reflection element of the lowermost layer may be opaque.

A reflective display device of the present invention is configured in such a manner that the wavelength selective reflection unit is aligned in matrix.

This allows for providing an easily produced reflective display device which is reduced in the amount of power consumption.

The reflective display device of the present invention may carry out white display while no voltage is applied to the MEMS.

According to the configuration, no application of a voltage to the MEMS is required in a state in which white display is carried out by the reflective display device, and in a state in which display of a color other than white is to be carried out, it is just necessary to continuously apply a fixed voltage to the MEMS of the wavelength selective reflection element which is to be switched OFF. Hence, it is possible to achieve low power consumption as compared to a conventional display device.

Moreover, particularly in a case where the reflective display device is used for electronic paper which mainly displays black characters on a white background, the area of the white display tends to be greater than the area of the black display. Hence, as compared to a configuration in which black display is carried out while no voltage is applied to the MEMS, it is possible to further reduce the power consumption.

The reflective display device of the present invention may carry out black display while no voltage is applied to the MEMS.

The present invention is suitably used for reflective display devices which carry out display of information with use of ambient light as a light source.

### REFERENCE SIGNS LIST

1 display device (reflective display device)
10 wavelength selective reflection element
10R wavelength selective reflection element
10G wavelength selective reflection element
10B wavelength selective reflection element
10r wavelength selective reflection element
10g wavelength selective reflection element
10b wavelength selective reflection element
11 guide-mode resonant grating
12 upper transparent plate (transparent plate)
13 lower transparent plate (substrate)
14 MEMS switch (MEMS)
14a first electrode
14b second electrode
15 MEMS switch (MEMS)
15a first electrode
15b second electrode
21a wire
21b wire
22a wire
22b wire
30 wavelength selective reflection unit
30A wavelength selective reflection unit
37 partition (light shielding wall)
40 wavelength selective reflection unit

1. A wavelength selective reflection element comprising:
a transparent plate on which a guide-mode resonant grating is formed;
a substrate disposed facing the transparent plate; and
MEMS being microelectromechanical systems, provided on (i) a side of one edge of the substrate and a corresponding one edge of the transparent plate and (ii) a side of another edge of the substrate and a corresponding another edge of the transparent plate, the side of the another edge being a side of an edge of the substrate and a corresponding edge of the transparent plate which faces the side of the one edge,
at least one of the MEMS being driven to cause a change in a gap provided between the transparent plate and the substrate.

2. The wavelength selective reflection element according to claim 1, wherein each of the MEMS comprises:
a first electrode provided on a side on which the transparent plate is disposed; and
a second electrode provided on a side on which the substrate is disposed,
the first electrode and the second electrode being disposed so that a voltage is applied therebetween.

3. The wavelength selective reflection element according to claim 1, wherein the substrate is transparent.

4. The wavelength selective reflection element according to claim 2, wherein
the first electrode of one of the MEMS is electrically connected to the first electrode of the other one of the MEMS, and the second electrode of the one of the MEMS is electrically connected to the second electrode of the other one of the MEMS.

5. The wavelength selective reflection element according to claim 2, wherein
the voltage is applied to a pair of the first electrode and the second electrode of one of the MEMS through a wire different from a wire for applying the voltage to a pair of the first electrode and the second electrode of the other one of the MEMS.

6. A wavelength selective reflection unit comprising:
a wavelength selective reflection element as set forth in claim 1, formed so that the guide-mode resonant grating selectively reflects red light;
a wavelength selective reflection element as set forth in claim 1, formed so that the guide-mode resonant grating selectively reflects green light; and
a wavelength selective reflection element as set forth in claim 1, formed so that the guide-mode resonant grating selectively reflects blue light,
the three wavelength selective reflection elements being disposed horizontally in one line.

7. The wavelength selective reflection unit according to claim 6, wherein
the wavelength selective reflection elements are partitioned by light shielding walls disposed between adjacent ones of the wavelength selective reflection elements.

8. A wavelength selective reflection unit comprising:
a wavelength selective reflection element as set forth in claim 3, formed so that the guide-mode resonant grating selectively reflects red light;
a wavelength selective reflection element as set forth in claim 3, formed so that the guide-mode resonant grating selectively reflects green light; and
a wavelength selective reflection element as set forth in claim 3, formed so that the guide-mode resonant grating selectively reflects blue light,
the wavelength selective reflection elements being stacked vertically on top of each other.

9. A wavelength selective reflection unit comprising:
a red light selective reflection unit in which wavelength selective reflection elements as set forth in claim 1 are disposed therein so as to include two wavelength selective reflection elements in one row and have at least two rows thereof, formed so that the guide-mode resonant grating selectively reflects red light;
a green light selective reflection unit in which wavelength selective reflection elements as set forth in claim 1 are disposed therein so as to include two wavelength selective reflection elements in one row and have at least two rows thereof, formed so that the guide-mode resonant grating selectively reflects green light; and
a blue light selective reflection unit in which wavelength selective reflection elements as set forth in claim 1 are disposed therein so as to include two wavelength selective reflection elements in one row and have at least two rows thereof, formed so that the guide-mode resonant grating selectively reflects blue light,
the red light selective reflection unit, the green light selective reflection unit, and the blue light selective reflection unit being disposed horizontally in one line.

10. A wavelength selective reflection unit comprising:
a red light selective reflection unit in which wavelength selective reflection elements as set forth in claim 3 are disposed therein so as to include two wavelength selective reflection elements in one row and have at least two rows thereof, formed so that the guide-mode resonant grating selectively reflects red light;
a green light selective reflection unit in which wavelength selective reflection elements as set forth in claim 3 are disposed therein so as to include two wavelength selective reflection elements in one row and have at least two rows thereof, formed so that the guide-mode resonant grating selectively reflects green light; and
a blue light selective reflection unit in which wavelength selective reflection elements as set forth in claim 3 are disposed therein so as to include two wavelength selective reflection elements in one row and have at least two rows thereof, formed so that the guide-mode resonant grating selectively reflects blue light,
the red light selective reflection unit, the green light selective reflection unit, and the blue light selective reflection unit being stacked vertically on top of each other.

11. A reflective display device in which a wavelength selective reflection unit as set forth in claim 6 is aligned in matrix.

12. The reflective display device according to claim 11, wherein white display is carried out while no voltage is applied to the MEMS.

13. The reflective display device according to claim 11, wherein black display is carried out while no voltage is applied to the MEMS.
